(19) United States
(12) Patent Application Publication
(10) Pub. No.: US 2017/0058892 A1
(43) Pub. Date: Mar. 2, 2017

(54) PUMP

(71) Applicant: MAHLE FILTER SYSTEMS JAPAN CORPORATION, Tokyo (JP)

(72) Inventors: Toshinobu HORIMATSU, Kawagoe-shi (JP); Satoshi MASUKURA, Higashimatsuyama-shi (JP)

(73) Assignee: MAHLE FILTER SYSTEMS JAPAN CORPORATION, Tokyo (JP)

(21) Appl. No.: 15/244,322

(22) Filed: Aug. 23, 2016

(30) Foreign Application Priority Data
Aug. 31, 2015 (JP) 2015-169928

(51) Int. Cl. F04C 2/332; F04C 15/00; F04C 29/12; F04C 13/00

(52) U.S. Cl. CPC F04C 2/332; F04C 13/001; F04C 15/0065; F04C 15/0069; F04C 15/0073; F04C 29/12; F04C 2210/206; F04C 2240/45; F04C 2240/30; F16H 61/0028

(57) ABSTRACT

An oil pump includes: an annular stator (2) having coils (22); a cylindrical outer rotor (3) having a plurality of permanent magnets (24); an inner rotor (4) positioned eccentrically to an inner peripheral side of the outer rotor (3); six linkage plates (5) which link between the outer rotor (3) and the inner rotor (4); and a drive shaft (6) on which the inner rotor (4) is attached. A pump action is obtained by rotating the outer rotor (3) and the inner rotor (action is obtained by rotating the outer rotor (3) and the inner rotor (4). Each of linkage plates (5) has a symmetrical cross sectional shape. A torque transmission is possible in the same way even if the outer rotor (3) is at a drive side and even if the inner rotor (4) is at the drive side.

### BACKGROUND OF THE INVENTION

(1) Field of the Invention

The present invention relates to a liquid purpose pump used, for example, as an oil pump of an internal combustion engine or an automatic transmission and, particularly, relates to a pump which is capable of a dual system drive of a mechanical drive and an electrical drive.

(2) Description of Related Art

A Japanese Patent Application First Publication No. 2013-072368 published on Apr. 22, 2015 exemplifies a previously proposed trochoid pump used as an automatic transmission purpose oil pump of a hybrid vehicle. This trochoid pump is structured in such a way that an output of an internal combustion engine is transmitted to an inner rotor via a one-way clutch. On the other hand, permanent magnets are disposed on an outer peripheral surface of an outer rotor and the permanent magnets and stator coils disposed on an outer peripheral side of the outer rotor are cooperated to function as an electrically driven motor. In other words, while the internal combustion engine of the hybrid vehicle is operated, the inner rotor is rotationally driven according to the output of the internal combustion engine so that the trochoid pump functions a kind of a mechanical pump. Then, while the internal combustion is stopped, the outer rotor is rotationally driven according to an electrically driven motor constituted by the permanent magnet and the stator coil at the outer peripheral side so that the trochoid pump functions as a kind of the electrically driven oil pump.

In addition, a Japanese Patent Application First Publication No. 2015-117695 published on Jun. 25, 2015 exemplifies a previously proposed rotary positive-displacement pump (this is called a pendulum slider pump) whose form is different from that of the trochoid pump. This pendulum slider pump includes: an inner rotor which integrally rotates with a drive shaft; and an outer rotor which rotates within a cam ring accompanied with a rotation of this inner rotor. A plurality of linkage plates are disposed between both of the inner rotor and the outer rotor to transmit a rotational force from the inner rotor of an inner peripheral side to the outer rotor of an outer peripheral side. These plurality of linkage plates serve to link between the inner rotor and the outer rotor and a space defined between the outer rotor and the inner rotor is partitioned into a plurality of chambers. The outer rotor is positioned eccentrically with respect to the inner rotor. Hence, by rotating both of the inner rotor and the outer rotor, a pump action similar to a vane pump is obtained.

### SUMMARY OF THE INVENTION

The trochoid pump disclosed in the Japanese Patent Application First Publication No. 2013-072368 is a general structure such that the inner rotor having an n number of lobes is meshed with the outer rotor having an (n+1) number of depression sections. In such a trochoid pump as described above, when a rotational drive for the outer rotor side is carried out to try to cause the inner rotor to be driven, a transmission of rotation is mainly carried out by means of a meshing of a single lobe. Thus, a driving force cannot smoothly be transmitted to the inner rotor. Especially, since the number of rotations of the inner rotor is larger than the number of rotations of the outer rotor (depending upon a ratio of the number of the lobes to the number of depression sections), the outer rotor drives in a form of an acceleration of the inner rotor. Thus, a slide resistance becomes very large. Hence, depending upon a state in which the rotational drive for the inner rotor side is carried out and a state in which the rotational drive for the outer rotor side is carried out, actual characteristics are considerably different from each other.

On the other hand, the pump of a form described in the Japanese Patent Application First Publication 2015-117695 can exhibit the pump action by rotationally driving the outer rotor side. However, depending upon a case where the rotational drive for the inner rotor side is carried out and the outer rotor is driven by it and a case where the rotational drive for the outer rotor side and the inner rotor is driven by it, a torque transmission direction in linkage plates becomes an inverse relationship even if the rotational direction is the same. Since a well known linkage plate has an asymmetrical cross sectional shape with only one directional torque transmission taken into consideration, an efficiency at either one is reduced in a case where the torque transmission direction between the outer rotor and the inner rotor is bidirectional.

With these problems in mind, it is an object of the present invention to provide a pump which is capable of achieving both drives of an electrical drive using a motor section and a mechanical drive by means of a second drive source.

According to one aspect of the present invention, there is provided a pump, comprising: a housing including a suction port, a discharge port, and an annular stator; a cylindrical outer rotor rotatably disposed at an inner peripheral side of the stator, including a plurality of permanent magnets arranged on an outer peripheral surface of the outer rotor to constitute a motor section in cooperation with the stator, and a plurality of plate holding grooves, each plate holding groove having a letter C shape in cross section, being extended in an axial direction of the outer rotor, and being formed on an inner peripheral surface of the outer rotor; an inner rotor disposed at a position eccentric with respect to the outer rotor, disposed at an inner peripheral side of the outer rotor, constituting a space communicated with the suction port and the discharge port against the outer rotor, and having an outer peripheral surface on which a plurality of slots are formed in a radial direction of the inner rotor; a drive shaft interlinked with the inner rotor and rotationally driven by means of a second drive source; and a plurality of linkage plates, each linkage plate having a head section of a circular cross section swingably fitted into a corresponding one of the plate holding grooves and a bulged section of a triangular cross section slidably fitted into a corresponding one of the slots, configured to partition the space into a plurality of chambers, wherein each of the linkage plates includes torque transmission surfaces on both surfaces of a corresponding one of the bulge sections to transmit rotational forces mutually between the outer rotor and the inner rotor and has a symmetrical cross sectional shape with a plane passing through a swing center of a corresponding one of the head sections as a center.

In such a structure as described above, the outer rotor is rotationally driven using the motor section constituted by the stator at the housing side and the permanent magnets at the outer rotor so that the inner rotor is driven (follows) via the plurality of linkage plates and a pump action is obtained according to a movement of the plurality of chambers partitioned by the linkage plates toward a peripheral direction of the inner rotor. In addition, the drive shaft is rotationally driven by means of the second drive source so that the inner rotor is rotated and the outer rotor is driven via the plurality of linkage plates. Then, the same pump action is obtained according to the peripheral directional movement of the plurality of chambers partitioned by the linkage plates. In each of drive directions, the inner rotor makes one rotation while the outer rotor makes one rotation.

It should, herein, be noted that each of the plurality of linkage plates has the head section swingably supported in a corresponding one of the plate holding grooves formed on the inner peripheral surface of the outer rotor and each of the triangular cross sectioned bulge sections swings and moves forward and backward within a corresponding one of the respectively slots so that a torque transmission between the outer rotor and the inner rotor is carried out. When the outer rotor is driven by means of the motor section, one of the torque transmission surfaces which is one of the surfaces of each of the bulge sections presses one of the pair of inner wall surfaces of the corresponding one of the slots of the inner rotor in the peripheral direction. When the inner rotor is driven by means of the second drive source, the other of the pair of inner wall surfaces of the corresponding one of the slots presses the other of the torque transmission surfaces of the corresponding one of the bulge sections in the peripheral direction. Since each of the linkage plates has a symmetrical cross sectional shape, a favorable torque transmission in each of the drive directions can be carried out.

In a specific aspect of the present invention, a shape of each of the bulged sections is determined in such a way that, when at least any one of the linkage plates falls in a first dynamic power transmission angle range determined for an eccentric direction between the outer rotor and the inner rotor, one of the torque transmission surfaces of the one of the linkage plates makes a surface contact on one of a pair of inner wall surfaces of a corresponding one of the slots in parallel and, when at least any one of the linkage plates falls in a second dynamic power transmission angle range determined for the eccentric direction between the outer rotor and the inner rotor, the other of the torque transmission surfaces of the one of the linkage plates makes the surface contact on the other of the pair of inner wall surfaces of the corresponding one of the slots in parallel.

In other words, when either of the torque transmission surfaces makes the surface contact on one of the surfaces of the corresponding one of the slots in substantially parallel, a maximum torque is transmitted between the linkage plates and the slots. Hence, the torque transmission is carried out via the linkage plates only within a constant dynamic power transmission angle range with a particular position (angular position) at which such a relative posture is obtained as a center. When either one of the outer rotor and the inner rotor is driven, the torque transmission is carried out in the first dynamic power transmission angle range. When the other of the outer rotor and the inner rotor is driven, the torque transmission is carried out in the second dynamic power transmission angle range. Since each of linkage plates has the symmetrical cross sectional shape, the first dynamic power transmission angle range and the second dynamic power transmission angle range occur approximately symmetrically with the eccentric direction between the first and second dynamic power transmission angle ranges and provide angle ranges of mutually equal magnitudes.

In a preferred aspect of the present invention, the inner rotor is attached onto the drive shaft and the drive shaft is mechanically driven through an output of an internal combustion engine via a one-way clutch. In such a structure as described above, for example, in a hybrid vehicle, if the internal combustion engine is rotated in a state in which the motor section is not electrically driven, the inner rotor is driven via the drive shaft. Then, in a state in which the internal combustion engine is stopped, the motor section drives the outer rotor so that the one-way clutch runs idle and the pump is electrically driven in the state in which the internal combustion engine is stopped.

Or alternatively, in place of the one-way clutch, the output of the internal combustion engine mechanically serves to drive the inner rotor via a clutch mechanism which is capable of a control of a connection and/or a release from an external.

### BRIEF DESCRIPTION OF THE DRAWINGS

FIG. 1 is a plan view representing a pump according to the present invention in a state in which a cover is removed.

FIG. 2 is a cross sectional view of the pump cut away along a line of A-A shown in FIG. 1.

FIG. 3 is an exploded perspective view of the pump shown in FIGS. 1 and 2.

FIG. 4 is an expansion view representing a cross sectional shape if a linkage plate.

FIG. 5 is a cross sectional view representing a preferred embodiment of a clutch mechanism used in a drive shaft.

### DETAILED DESCRIPTION OF THE INVENTION

Hereinafter, a preferred embodiment of a pump according to the present invention will be described on a basis of attached drawings in order to facilitate a better understanding of the present invention.

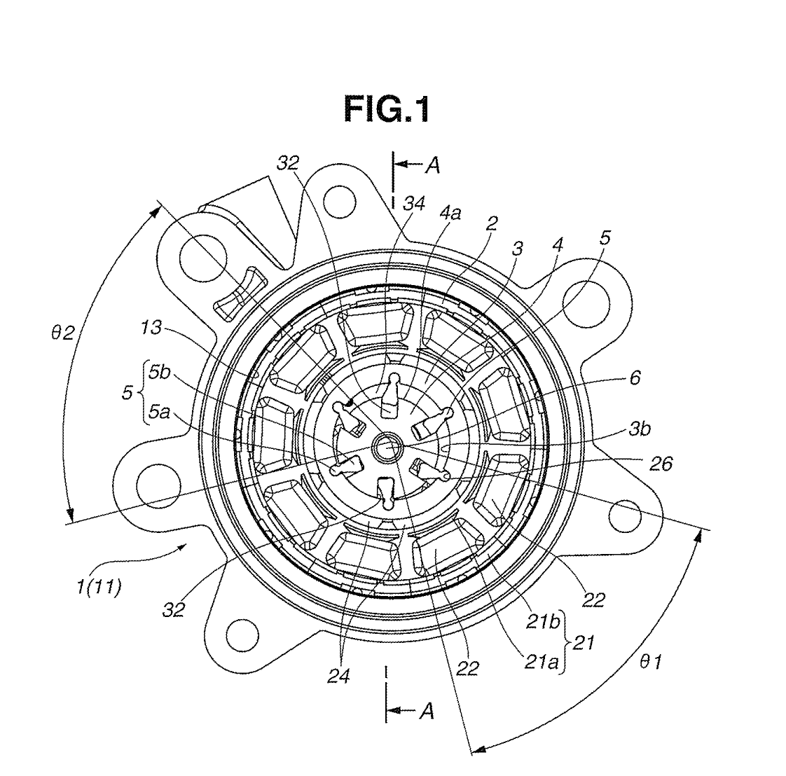

FIGS. 1 through 3 show the preferred embodiment in which the pump according to the present invention is, for example, applied as an oil pump for an automatic transmission in a hybrid vehicle.

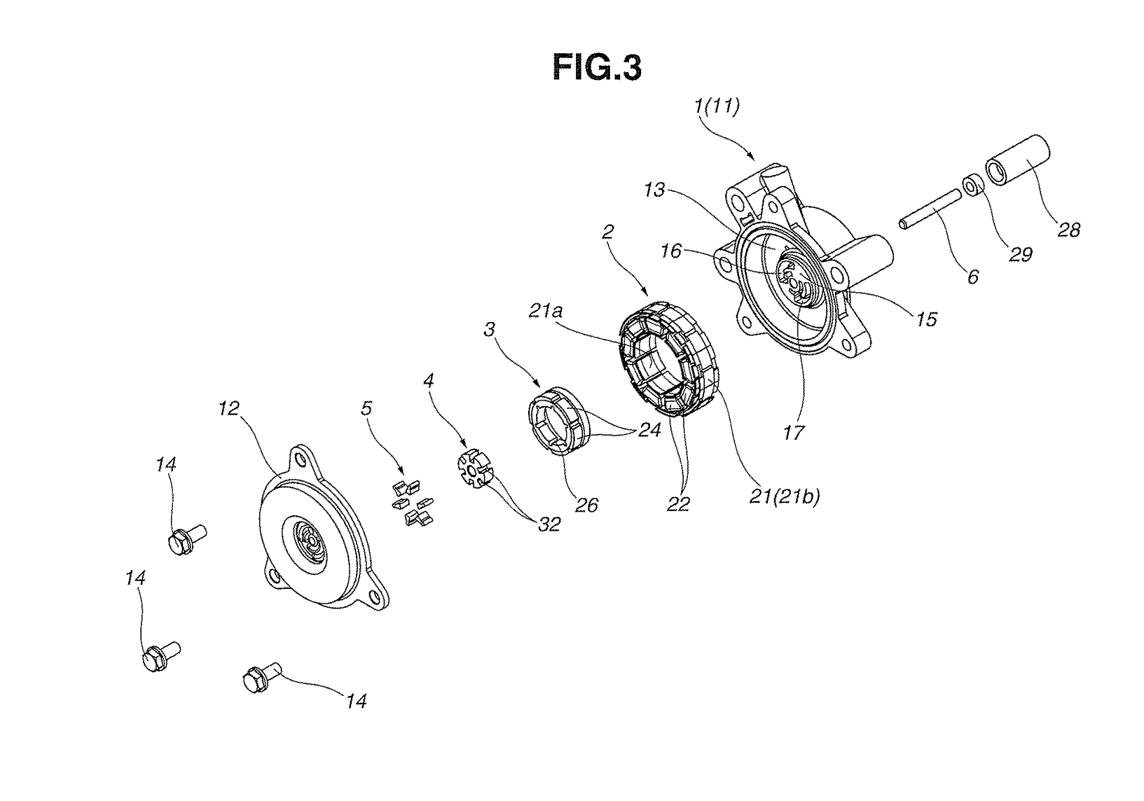

This oil pump, as shown in FIG. 3, mainly includes: a hollow disk-shaped housing 1 attached at an appropriate position of the automatic transmission or an internal combustion engine; an annular stator 2 housed in this housing 1; a cylindrical outer rotor 3 disposed at an inner peripheral side of this stator 2; an inner rotor 4 disposed at an inner peripheral side of outer rotor 3 and at a position eccentric with respect to outer rotor 3; a plurality (for example, 6) of linkage plates 5 linking between outer rotor 3 and inner rotor 4; and a drive shaft 6 supported around housing 1.

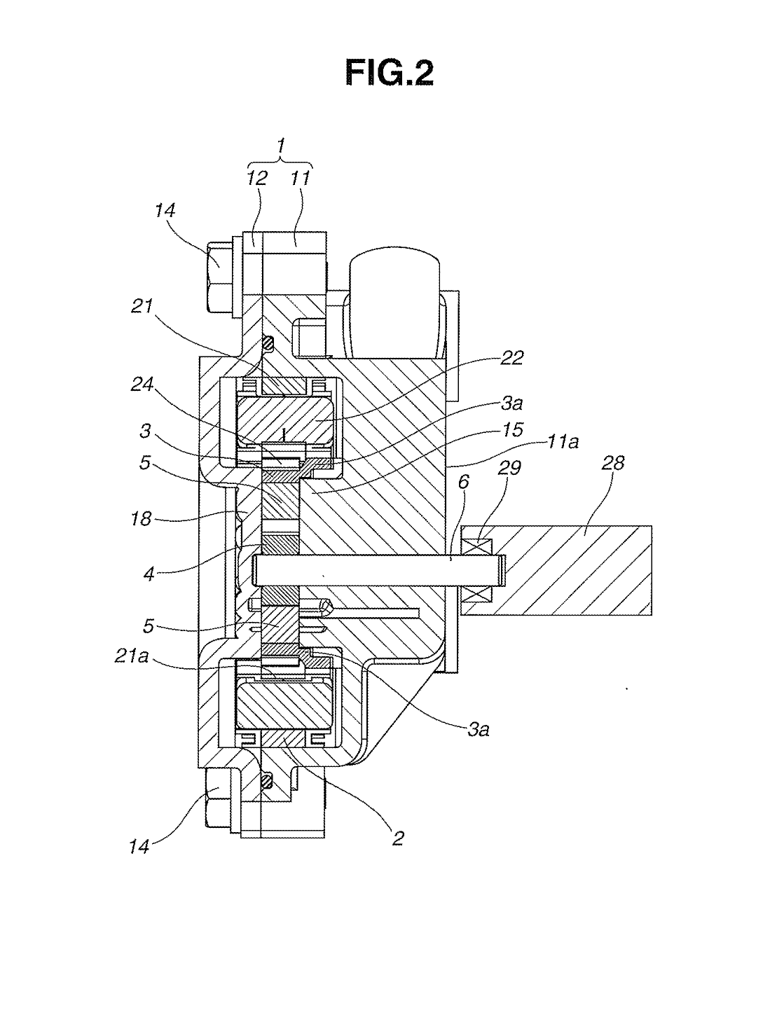

Above-described housing 1 is constituted by and divided into: a main frame 11 on which a stator housing chamber 13 is formed as a recessed section; and a cover 12 which closes an opening surface of stator housing chamber 13 in combination with this main frame 11. These main frame 11 and cover 12 are mutually fastened together with a plurality of bolts 14. A side plate section 15 is formed at a center section of stator housing chamber 13 as a circular protrusion section. Each of a suction port 16 and a discharge port 17 is formed in a crescent shape on an end surface of side plate section 15. In addition, as shown in FIG. 2, another side plate section 18 is formed at the center section of cover 12 as the circular protrusion section. It should be noted that the suction port and the discharge port may be provided on other side plate section 18 at cover side 12. In other words, the suction port may be provided on at least one of two side plate sections 15, 18 and the discharge port may similarly be provided on at least one of two side plate sections 15 and 18. In addition, one of the side plates having the suction port or the discharge port can be constituted by a plate member which is separate from housing 1 itself. Drive shaft 6 is rotatably supported at two locations of main frame 11 and cover 12 and is penetrated through main frame 11 so that one end section of drive shaft 6 is projected from a bottom surface 11a of main frame 11. This drive shaft 6 is arranged at a position eccentric by a predetermined quantity (distance) with respect to a center of each of side plate sections 15, 18. It should be noted that a term of “axial direction” used in the present specification means a direction along a center axial line of drive shaft 6.

Stator 2 is a constituent of a motor section together with outer rotor 3. Stator 2 includes: a 9-slot stator core 21 made of laminated iron cores having a plurality, for example, nine of poles 21a and annular yokes 21b; and coils 22 wound on respective poles 21a. This stator 2 is arranged so as to concentrically enclose side plate sections 15, 18 within stator housing chamber 13 of housing 1.

Outer rotor 3 constitutes a pump section together with inner rotor 4 and, simultaneously, is a constituent corresponding a rotor of the motor section. Outer rotor 3 is, as a whole, cylindrical and a plurality of, for example, plate-like six permanent magnets 24 bent in arc shapes are attached on an outer peripheral surface of outer rotor 3 at equal intervals. N poles and S poles of permanent magnets 24 are alternatingly arranged to constitute the motor section in cooperation with stator 2. These permanent magnets 24 are opposed against inner peripheral surfaces of poles 21a of stator 2 via a slight air gap. A bearing section 3a (refer to FIG. 2) disposed on one end section of cylindrical outer rotor 3 and having a diameter slightly larger than the other part is rotatably fitted to the outer periphery of side plate section 15 of main frame 11. Thus, outer rotor 3 is rotatably supported on housing 1.

Plate holding grooves 26, each recessed in cross sectional circular or cross sectional letter C shape, are formed at equal intervals at a plurality of locations, for example, six locations on inner peripheral surface 3b of outer rotor 3. Each plate holding groove 26 is extended in the axial direction of outer rotor 3 and both ends of each plate holding groove 26 is opened to the end surface of outer rotor 3.

Inner rotor 4 disposed at the inner periphery side of outer rotor 3 is positioned eccentrically from the center of outer rotor 3 so that a part of outer peripheral surface 4a of inner rotor 4 comes close to inner peripheral surface 3b of outer rotor 3 and inner rotor 4 is attached to drive shaft 6 to rotate integrally with drive shaft 6. In other words, inner rotor 4 can rotationally be driven with drive shaft 6. An internal combustion engine side drive shaft 28 which rotates by means of an engine output of the internal combustion engine which provides a second drive source is connected to one end section of drive shaft 6 via a one-way clutch 29. This one-way clutch 29 is in an engaged state in a state in which the internal combustion engine is driven and internal combustion engine side drive shaft 28 rotationally drives inner rotor 4. When internal combustion engine side drive shaft 28 is stopped and inner rotor 4 (in other words, drive shaft 6) is electrically driven by means of the motor section, in other words, when a rotational speed of drive shaft 6 is higher than the rotational speed of internal combustion engine side drive shaft 28, one-way clutch 29 runs idle, viz., becomes a released state.

Six rectangular slots 32 which correspond to the number of plate holding grooves 26 are radially formed on outer peripheral surface 4a of inner rotor 4. In more details, slots 32 have a mutually parallel pair of inner wall surfaces and the pair of inner wall surfaces are formed along a radius line of inner rotor 4 so that the pair of inner wall surfaces become parallel to the radius line. Each slot 32 is extended in the axial direction of inner rotor 4 and both ends of each of slots 32 are opened to end surfaces of inner rotor 4.

As a result of an eccentricity of inner rotor 4 with respect to inner peripheral surface 3b of outer rotor 3, a crescent-shaped space, as shown in FIG. 1, is formed between inner rotor 4 and outer rotor 3.

Then, this crescent-shaped space is, further, partitioned into six chambers 34 by means of six linkage plates 5. Each of these linkage plates 5 is formed in a plate-like shape having a pendulum shaped cross sectional shape approximating to a substantial triangular shape. A head section 5a located at an outer peripheral end of each linkage plate 5 is swingably fitted to a corresponding one of plate holding grooves 26 of outer rotor 3 and a bulged section 5b bulged out in the peripheral direction at the inner peripheral side of each linkage plate 5 is swingably inserted into a corresponding one of slots 32 of inner rotor 4.

As is easily understood from FIG. 1, a distance between inner peripheral surface 3b of outer rotor 3 and outer peripheral surface 4a of inner rotor 4 is varied in accordance with rotational positions of mutually eccentric outer rotor 3 and inner rotor 4 and a volume of each chamber 34 partitioned by means of linkage plates 5 is increasingly or decreasingly varied. Hence, outer rotor 3 and inner rotor 4 are rotated in a clockwise direction in FIG. 1 so that a pump action is obtained by which oil is pumped (pressure feed) from suction port 16 to discharge port 17 disposed on side plate sections 15, 18.

In a hybrid vehicle having the internal combustion engine and a running purpose motor/generator as drive sources of the vehicle, the internal combustion engine is driven only at a time of necessity and is in a stopped state at a time of unnecessity. During an operation of the internal combustion engine, drive shaft 6 is rotationally driven by means of internal combustion engine side drive shaft 28 via one-way clutch 29. Hence, from among outer rotor 3 and inner rotor 4 constituting the pump section, inner rotor 4 is a drive side and outer rotor 3 is driven. In other words, in association with the rotation of inner rotor 4, the inner wall surface of slots 32 presses linkage plates 33 fitted to slots 32 in the peripheral direction. Then, since head section 5a of linkage plate 5 is linked to plate holding groove 26, the torque is transmitted to outer rotor 3 and outer rotor 3 is rotated together with inner rotor 4. Thus, the above-described pump action is obtained.

In addition, during the stop of the internal combustion engine, outer rotor 3 is rotationally driven by means of a motor section constituted by outer rotor 3 on which permanent magnets 24 are disposed and stator 2. In other words, in the above-described preferred embodiment, coils 22 and permanent magnets 24 constitute a three-phase 6-pole 9-slot motor section. Coils 22 are driven via an appropriate motor drive circuit including an inverter so that outer rotor 3 can be rotated within stator 2. Hence, from among outer rotor 3 and inner rotor 4 constituting the pump section, outer rotor 3 becomes the drive side and inner rotor 4 is driven. In other words, when outer rotor 3 is rotated, linkage plates 5 supported on plate holding grooves 26 press inner peripheral surfaces of corresponding slots 32 in the peripheral direction and the torque is transmitted to inner rotor 4. Thus, inner rotor 4 is rotated together with outer rotor 3 and the above-described pump action is, all in the same way, obtained.

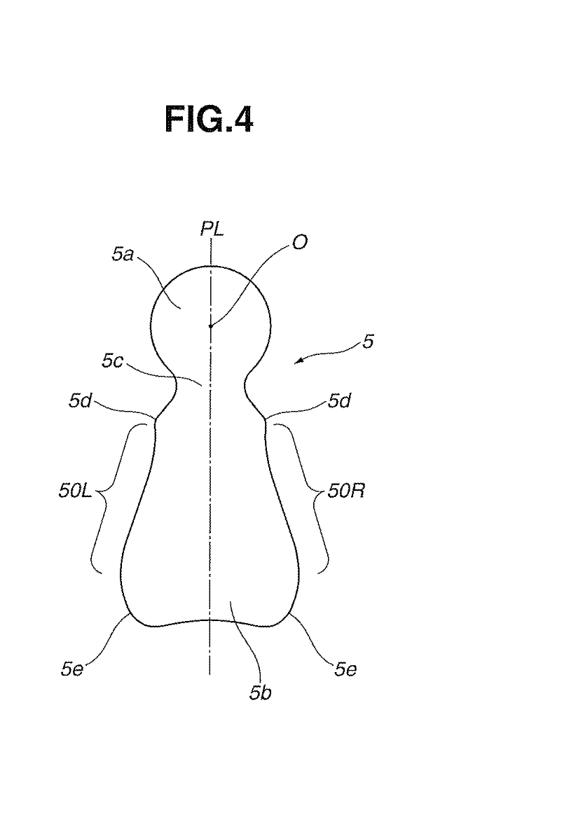

FIG. 4 more specifically shows a cross sectional shape of each of linkage plates 5 which mutually transmit the rotational force between outer rotor 3 and inner rotor 4. It should be noted that each of linkage plates 5 has a constant cross sectional shape over a whole length in the axial direction. Hence, an outside shape (appearance form) of an end section viewed from FIG. 1 and the cross sectional shape are not changed. As described before, each of linkage plates 5 includes: head section 5a having a cross sectional circular shape and swingably fitted into a corresponding one of plate holding grooves 26; and bulged section 5b bulged out (expanded) in a substantially triangular shape. In more details, a slender, constricted neck section 5c is provided between head section 5a and bulged section 5b in order to largely secure a swing angle with respect to the corresponding one of plate holding grooves 26 and, adjacent to this neck section 5c, a pair of shoulder sections 5d are provided which are slightly projected in leftward and rightward directions in FIG. 4. Then, substantially straight line torque transmission surfaces 50 (50R, 50L) are provided between a pair of corner sections 5e which are outer peripheral ends of bulge section 5b and pair of shoulder sections 5d. It should be noted that, in a case where left and right torque transmission surfaces 50 are distinguished, the left torque transmission surface in FIG. 4 is called a first torque transmission surface 50L and the right torque transmission surface in FIG. 4 is called a second torque transmission surface 50R. Outer peripheral side portions of torque transmission surfaces 50 (a lower side portion of FIG. 4) and corner sections 5e continued from the outer peripheral side portions of torque transmission surfaces 50L, 50R form moderate curved surfaces convex toward the outside direction in such a way that two left and right locations of the outer peripheral side portions of torque transmission surfaces 50 (50L, 50R) and corner sections 5e continued therefrom can be moved along the inner wall surface of the corresponding one of slots 32 when these are swung within the corresponding one of slots 32 having a parallel width as shown in FIG. 1. In other words, when each of linkage plates 5 provides a posture slanted with respect to the corresponding one of slots 32, a curved shape of the lower part in FIG. 4 of bulge section 5b is set in order for two points in the proximity of pair of corner sections 5e to be maintained in a substantially contacted state on the left and right inner wall surfaces.

The cross sectional shape of each of linkage plates 5 shown in FIG. 4 has a bilaterally symmetric shape with a plane PL passing through a swing center O of head section 5a as a center. Hence, first torque transmission surface 50L and second torque transmission surface 50R are symmetrically formed with plane PL as the center.

In this way, each of linkage plates 5 has the bilaterally symmetrical cross sectional shape. Thus, the oil pump in the above-described preferred embodiment can equally obtain smooth actions and can equivalently obtain the efficiency when inner rotor 4 is rotationally driven by means of the output of the internal combustion engine and when outer rotor 4 is rotationally driven by means of the motor section.

In other words, since inner rotor 4 is eccentric to inner peripheral surface 3b of outer rotor 3, as described before, each of linkage plates 5 described above moves forward and backward and swings within the corresponding one of slots 32 in accordance with a rotational position. If a corresponding one of each of linkage plates 5 is contacted on the pair of inner wall surfaces of corresponding one of slots 32 in the vicinity of pair of corners 5e and left and right (first and second) torque transmission surfaces 50 (50L, 50R) are in a separation state from the pair of inner wall surfaces of the corresponding one of slots 32 (in other words, a posture such that center plane PL of the corresponding one of each of linkage plates 5 is along a radius line of inner rotor 4), the corresponding one of linkage plates 5 can freely be swung. Thus, the torque transmission between both of the corresponding one of linkage plates 5 and the corresponding one of slots 32 (outer rotor 3 and inner rotor 4) becomes impossible. Then, as the positional relationship between the corresponding one of each of linkage plates 5 and the corresponding one of slots 32, when one of torque transmission surfaces 50 is surface contacted on the corresponding one of inner peripheral surfaces of the corresponding one of slots 32 in substantially parallel, a maximum torque transmission is performed. Hence, only when one of linkage plates 5 falls in a particular angle range while individual linkage plates 5 are moved through 360°, a substantial torque transmission is possible.

In more details, when inner rotor 4 is rotationally driven and outer rotor 3 is driven (follows) and at least any one of linkage plates 5 is present in a first power transmission angle range θ1 shown in FIG. 1, the torque transmission via the one of linkage plates 5 is carried out. In other words, when the one of linkage plates 5 is present at a substantially center angular position of this first power transmission angle range θ1, first torque transmission surface 50L of the one of linkage plates 5 is surface contacted on one of the pair of inner wall surfaces of the corresponding one of slots 32 (a surface which provides a rear side with respect to the clockwise direction rotation in FIG. 1) in substantially parallel. Since inner rotor 4 which is the drive side is rotated in the clockwise direction shown in FIG. 1, first torque transmission surface 50L of the one of linkage plates 5 is pressed by the one of the pair of inner wall surfaces of corresponding one of slots 32 in the peripheral direction and the torque is transmitted to outer rotor 3.

On the other hand, when outer rotor 3 is rotationally driven and inner rotor 4 is driven (follows) and at least any other one of linkage plates 5 is present in a second power transmission angle range θ2 shown in FIG. 1, the torque transmission via the other one of linkage plates 5 is carried out. In other words, when the other one of linkage plates 5 is present at a substantially center angular position of this second power transmission angle range θ2, second torque transmission surface 50R of the other one of linkage plates 5 is surface contacted on the other of the pair of inner wall surfaces of the corresponding one of slots 32 (a surface which provides a front side with respect to the clockwise direction rotation in FIG. 1) substantially parallel. Since outer rotor 3 which is the drive side is rotated in the clockwise direction shown in FIG. 1, the other of the pair of inner wall surfaces of the corresponding one of slots 32 is pressed by second torque transmission surface 50R of the other one of linkage plates 5 in the peripheral direction and the torque is transmitted to inner rotor 4.

Since first torque transmission surface 50L and second torque transmission surface 50R are symmetrically formed, in FIG. 1, first power transmission angle range θ1 and second power transmission angle range θ2 are mutually symmetrically obtained and provide mutually equal angle ranges, with an angular position along an eccentric direction of inner rotor 4 with respect to outer rotor 3 as a center. Hence, even if inner rotor 4 is the drive side and even if outer rotor 3 is the drive side, the torque transmission at mutually equal efficiencies is carried out and the same characteristics can be obtained.

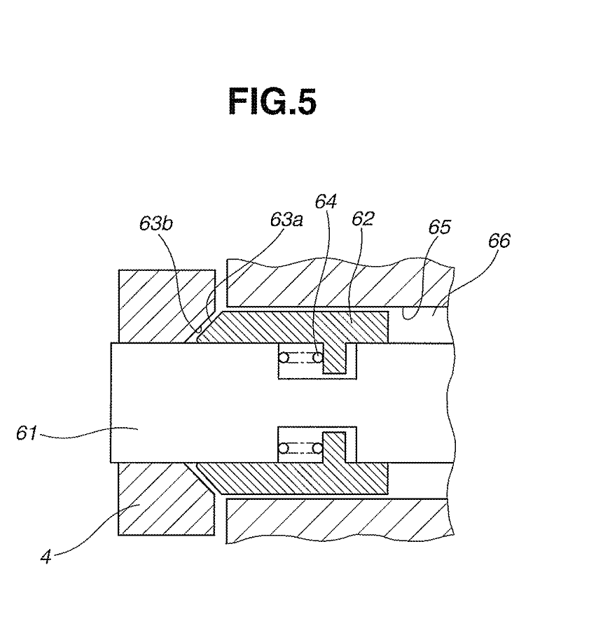

Next, FIG. 5 shows another preferred embodiment in which an externally controllable clutch mechanism is interposed between a drive side 61 driven by means of the output of the internal combustion engine and inner rotor 4, in place of one-way clutch 29 in the above-described embodiment. In the other embodiment, drive side 61 is not fixed onto inner rotor 4 but is rotatably fitted into a center hole of inner rotor 4. Then, a cylindrical clutch member 62 which is a main constituent of the clutch mechanism is disposed on an outer periphery of drive side 61. This clutch member 62 is fitted to drive side 61 so as to be unrotational and axially slidable with respect to drive side by means of, for example, a spline coupling, a key coupling, or so forth. This clutch member 62 is rotatably retained in bearing hole 65 of main frame 11 of housing 1 described before together with drive side 61. Tapered mesh surfaces 63a, 63b which are slanted at appropriate angles with respect to a center axle of drive side 61 are respectively formed between a tip of this clutch member 62 and inner rotor 4. Teeth sections are provided on these mesh surfaces 63a, 63b along a radius direction mutually meshed.

Clutch member 62 is biased against drive side 61 in a backward direction by means of a coil spring 64 so that mesh surfaces 63a, 63b are mutually separated from each other. In addition, a hydraulic pressure chamber 66 is faced against an end surface of clutch member 62 and interposed between drive side 61 and bearing hole 65. The clutch mechanism is switched by introducing an external commanded hydraulic pressure into this hydraulic pressure chamber 66.

That is, in a case where the internal combustion engine is stopped and the electrical drive is performed by means of the motor section, meshing of mesh surfaces 63a 63b are released by dropping the commanded hydraulic pressure and drive side 61 and inner rotor 4 becomes mutually relative rotatable.

On the contrary, in a case where the mechanical drive is performed by means of the output of the internal combustion engine, mesh surfaces 63a, 63b are mutually engaged by introducing a predetermined commanded hydraulic pressure into hydraulic pressure chamber 66. Thus, inner rotor 4 is rotationally driven by means of the output of the internal combustion engine.

According to the present invention, the pump which is capable of both drives of the electrical drive using the motor section and the mechanical drive by means of the second drive source can be provided. Especially, equivalent efficiencies and characteristics can be secured between the electrical drive and the mechanical drive.

This application is based on a prior Japanese Patent Application No. 2015-169928 filed in Japan on Aug. 31, 2015. The entire contents of this Japanese Patent Application No. 2015-169928 are hereby incorporated by reference. Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A pump, comprising:
a housing including a suction port, a discharge port, and an annular stator;
a cylindrical outer rotor rotatably disposed at an inner peripheral side of the stator, including a plurality of permanent magnets arranged on an outer peripheral surface of the outer rotor to constitute a motor section in cooperation with the stator, and a plurality of plate holding grooves, each plate holding groove having a letter C shape in cross section, being extended in an axial direction of the outer rotor, and being formed on an inner peripheral surface of the outer rotor;
an inner rotor disposed at a position eccentric with respect to the outer rotor, disposed at an inner peripheral side of the outer rotor, constituting a space communicated with the suction port and the discharge port against the outer rotor, and having an outer peripheral surface on which a plurality of slots are formed in a radial direction of the inner rotor;
a drive shaft interlinked with the inner rotor and rotationally driven by means of a second drive source; and
a plurality of linkage plates, each linkage plate having a head section of a circular cross section swingably fitted into a corresponding one of the plate holding grooves and a bulged section of a triangular cross section slidably fitted into a corresponding one of the slots, configured to partition the space into a plurality of chambers, wherein each of the linkage plates includes torque transmission surfaces on both surfaces of a corresponding one of the bulge sections to transmit rotational forces mutually between the outer rotor and the inner rotor and has a symmetrical cross sectional shape with a plane passing through a swing center of a corresponding one of the head sections as a center.

2. The pump as claimed in claim 1, wherein the inner rotor is attached onto the drive shaft and the drive shaft is mechanically driven through an output of an internal combustion engine via a one-way clutch.

3. The pump as claimed in claim 1, wherein the drive shaft is mechanically driven through an output of an internal combustion engine and a rotation of the drive shaft is transmitted to the inner rotor via a clutch mechanism which is capable of a control of a connection and/or a release from an external.

4. The pump as claimed in claim 1, wherein a shape of each of the bulged sections is determined in such a way that, when at least any one of the linkage plates falls in a first dynamic power transmission angle range determined for an eccentric direction between the outer rotor and the inner rotor, one of the torque transmission surfaces of the one of the linkage plates makes a surface contact on one of a pair of inner wall surfaces of a corresponding one of the slots in parallel and, when at least any one of the linkage plates falls in a second dynamic power transmission angle range determined for the eccentric direction between the outer rotor and the inner rotor, the other of the torque transmission surfaces of the one of the linkage plates makes the surface contact on the other of the pair of inner wall surfaces of the corresponding one of the slots in parallel.
